(19) United States
(12) Patent Application Publication
(10) Pub. No.: US 2011/0027631 A1
(43) Pub. Date: Feb. 3, 2011

(54) TEMPERATURE-CONTROLLED BATTERY DEVICE AND METHOD FOR IT

(76) Inventor: Martin Holger Koenigsmann, Stuttgart (DE)

Correspondence Address: KENYON & KENYON LLP, ONE BROADWAY, NEW YORK, NY, 10004, US

(21) Appl. No.: 12/733,780

(22) PCT Filed: Sep. 15, 2008
(86) PCT No.: PCT/EP2008/062221

§ 371 Date: Oct. 18, 2010

(30) Foreign Application Priority Data
Sep. 21, 2007 (DE) 10 2007 045 183.2

(51) Int. Cl. H01M 10/50

(52) U.S. Cl. 429/62

(57) ABSTRACT

A battery device having at least one battery and having at least one heating and/or cooling device temperature-controlling the battery. It is provided that the battery, submerged in an heating and/or cooling medium, is situated in a housing that accommodates the heating and/or cooling medium. The present invention also relates to a corresponding method.

### BACKGROUND OF THE INVENTION

1. Field of the Invention

The present invention relates to a battery device having at least one battery and having at least one heating and/or cooling device temperature-controlling the battery.

2. Description of Related Art

In many fields of technology high-powered electrical energy stores are required, for instance, in hybrid vehicles and electric vehicles. But high-powered electrical energy stores are also required in other industrial applications, such as in pitch systems for wind wheels and in solar installations. Depending on the field of application and use, systems coming into consideration for the respective area of use are selected from the large number of storage systems that are available, particularly with respect to their physico-chemical composition, and are configured for the application purpose. A careful selection has to be made, particularly with respect to the temperature ranges occurring in practical applications, since, for instance, high-powered lithium ion accumulator systems only work reliably in a relatively narrow temperature range such as −10° C. to +50° C. Outside this temperature range the electrical performance is insufficient, or the accumulator may even fail. That is why extraordinarily great attention is paid, in the related art, to the selection of a certain battery or accumulator type, for a certain field of use. In this connection, one should also observe that high-powered electrical energy stores are usually put together using modules in which a plurality of individual cells are combined with one another. Temperature development during operation is a particular problem, especially in such a case, since individual cells heat one another, and heat dissipation from inside the module is difficult. Such increased local temperatures ensure a reduction in the service life of the battery, and endanger the applicability of the entire module. It is therefore known in the related art that one may cool battery modules, that have been selected according to their temperature range. JP 2006-100123, for example, provides a battery device in which air duct channels are situated between individual cells, through which cooling air is blown using a fan. A similar device is provided by JP 2006-185788, in which, for the purpose of cooling individual cells of a battery module, wind duct channels having adjustable flaps for aimed wind guidance are applied on the underside of the module, namely, between the battery module and a housing shell that surrounds it from underneath. It is known from US 2005/0210662 Al that one may position individual lithium cells in a housing which provides a wind duct system for cooling the cells. There is a disadvantage in these devices. It is true that drainage of waste heat created in the operation of the battery device may be achieved, with individual cells experiencing uniform cooling, that is, that not one cell is cooled more or less greatly than, for example, an adjacent cell, yet, on the inside of such cell arrangements, because of the situation of the wind duct channels, local temperature superelevations occur, for instance, at the sidewalls of the individual cells which do not border directly on an air duct channel. Another disadvantage is that only waste heat is able to be dissipated, that is, the temperature range of the battery device is widened slightly only upwards. Still, a careful selection has to be made of the battery type to be used, with respect to the provided field of utilization, particularly with respect to the temperature range in which the battery device is to be used, and one has to reckon with restrictions in cold operation.

### SUMMARY OF THE INVENTION

It is the object of the present invention to provide a high-powered electrical energy store which avoids the disadvantages mentioned, and which is able to be used, in this connection, particularly in a very wide energy range.

A battery device is proposed for this, having at least one battery and having at least one heating and/or cooling device temperature-controlling the battery, it being also provided that the battery, submerged in a heating and/or cooling medium, is situated in a housing that accommodates the heating and/or cooling medium. Accordingly, the battery device has a housing that may be shaped like a tub, for example, (that is, open at the top) or a housing closed on all sides. The battery (which naturally does not actually have to be a battery in the strict sense of the word, but may be designed as an accumulator; the term battery is only used because the terminology is customary in automotive technology) is surrounded by a heating and/or cooling medium, preferably in such a way that the battery is surrounded on all sides by the heating and/or cooling medium, so that an all-around heat transfer is able to take place from the battery to the heating and/or cooling medium or vice versa. This makes it possible, in a manner completely different from what is usual in the related art, not to have to select certain battery types according to the field of application, almost completely independent of the field of application provided. For, the temperature range that is predominantly encountered in the provided field of application, in which the battery is to be installed, becomes almost totally unimportant because of the immersion of the battery in the heating and/or cooling medium. Accordingly, the battery is not adjusted to the temperature range provided, but the temperature of the immediate surroundings of the battery is rather adapted to the specifications of the battery used. In this connection it is particularly possible to operate the battery in its preferred temperature range, that is, in the temperature range in which it develops its greatest electrical performance. In this way, one no longer has to accept any loss with regard to electrical performance in the edge regions of the preferred temperature range/working range of the battery, but rather the battery may be held at its preferred temperature level. Because of the housing, it is ensured hereby that a complete immmersion of the battery in the heating and/or cooling medium is always ensured.

In one preferred specific embodiment, the heating and/or cooling medium is circulated, a heating and/or cooling device circulating the heating and/or cooling medium. It is therefore possible, in this instance, to temperature-control the heating and/or cooling medium actively, that is, supply heat energy to, or drain heat energy from the heating and/or cooling medium, the circulation being essentially carried out as is known from the related art of heating and/or cooling circulations. In particular, in this instance, a heat dissipation device is provided for the heating and/or cooling medium, such as a heat exchanger that is generally known as a cooler, and a heat supply device as is known in any practical specific embodiment as a heating element, particularly also as a heat exchanger having a medium that, on average, has a higher temperature than the heating and/or cooling medium such as, for instance, the heated cooling water of an internal combustion engine.

In a further specific embodiment, the battery is enveloped on all sides by a hermetically sealing enclosure. By this is meant that the battery is shut off hermetically sealed from the heating and/or cooling medium, and thus a contact between the heating and/or cooling medium and the battery does not occur, due to the enclosure. As the enclosure, in this instance, all materials come into consideration which permanently assure the required sealing in the provided application range and particularly the temperature range.

In one preferred specific embodiment, the enclosure is a foil. Because of their low material thickness, foils permit a rapid passage of heat in both directions, and at the same time they are extraordinarily easy to adapt to the shape of the battery, without creating undesired cavities or, for instance, air entrapments between the foil and the battery, which could make the passage of heat more difficult. Because the batteries are enclosed individually by foil, and are completely surrounded by heating and/or cooling medium, local overheating phenomena, as are known from the related art, having the known air guidances in a housing, are effectively avoided.

In one particularly preferred specific embodiment, the inside of the enclosure is evacuated. By the evacuation of the inside of the enclosure, that is, of the space in which the battery is inserted, a complete, whole-surface contact of the enclosure is achieved without air entrapments, so that the passage of temperature takes place over the full surface and is unimpeded. At the same time, undesired influences on the battery, such as air entrapments, are avoided.

In a further preferred specific embodiment, the battery has encapsulated or bonded contact and/or terminal locations for insulation from the heating and/or cooling medium. Accordingly, an additional possibility is to insulate the individual cells/batteries only at their contact locations or terminal locations, and then, insulated in this manner, hang them directly into the heating and/or cooling medium, in order to achieve an even more improved heat transfer by the omission of the enclosure. This insulation of the contact and/or terminal locations may be implemented, for example, by bonding using an adhesive that is insoluble in the heating and/or cooling medium, for instance, using an epoxy resin. Similarly, it is possible to bond the contact and/or terminal locations using such an insulating material, for example, again using an epoxy resin. It is assumed, in this instance, that the batteries, that is, the individual cells as such, are not attacked or partially dissolved, for example, based on their nature, by the heating and/or cooling medium.

In another preferred specific embodiment, the heating and/or cooling medium is an incombustible medium. Because of this, even at relatively high temperatures, the danger potential of the battery device may be sharply reduced, since ignition of the heating and/or cooling medium and/or the battery device cannot take place on account of high temperatures. In a manner different from the related art, undesired risks of failure and/or of fire are surely avoided in this manner, especially in response to malfunctioning.

In another preferred specific embodiment, the heating and/or cooling medium is an electrically nonconductive medium. Even in the case of defects in the enclosures of batteries, this excludes the occurrence of contact-making of individual battery poles among one another, causing short circuits, undesired malfunctions, or even endangerment of the battery device or of the surroundings by electrical manifestations, such as electrical fires.

In one particularly preferred specific embodiment, the heating and/or cooling medium is a fireproofing agent, or contains one. In this connection, a fireproofing agent is any medium that suppresses existing fires, or fires in the process of being created, or is suitable for preventing their spreading.

Furthermore, a method is provided for temperature-controlling a battery device as recited in one or more of the preceding claims. According to this method, the batteries are placed together to form a battery device, a space remaining between the individual batteries. This may be done, for example, by positioning the individual batteries, using spacers applied between them. The batteries as individual cells are provided with an enclosure, and the latter is evacuated, so that it lies against the battery over the full contact surface without air entrapments. The batteries are then placed in a bath of heating and/or cooling medium, that was described above, for instance, hanged into it and fixed on clamps or wires, or laid into compartments separated by wire mesh, or built up one over another using the spacers mentioned, more or less according to the principle of a tightest close packing applied to cylindrical cells. The heating and/or cooling medium is then circulated in a circulatory system by a circulating pump, the temperature level of the heating and/or cooling medium being adjusted to the temperature level that is most practical for the batteries, that is, the temperature level at which the batteries develop their maximum performance. The adjustment of the temperature level of the heating and/or cooling medium is performed by heat exchangers known from the related art, which are used for draining or supplying heat energy, that is, for instance, plate-type heat exchangers and/or heating elements. The desired temperature level is monitored, in this instance, using a thermostatic device that is positioned in the circulatory system, or preferably will be positioned in the 12, which is used to connect housing 4 to a circulatory system 13 for heating and/or cooling medium 8. Interface 12 preferably has a thermostatic control 14 in this instance, which monitors the temperature of battery device 1, especially heating and/or cooling medium 8 in housing 4, and, corresponding to this temperature, controls circulatory system 13 and/or interface 12, for instance, via a circulating pump 25 that is situated in circulatory system 13, and/or by controlling a heating and/or cooling device 15 that is situated in circulatory system 13. Heating and/or cooling device 15, in this case, has an heat exchanger 16 which is used to drain the superfluous heat of heated heating and/or cooling medium 8 supplied to heating and/or cooling device 15; the latter may be an air heat exchanger 17, for example, or a liquid heat exchanger 18 connected to, or communicating with other circulatory systems, not shown here, in particular, cooling circulatory systems. In this connection, the only important thing is that heat exchanger 16 is suitable for draining superfluous heat energy, to the extent required, from the heated heating and/or cooling medium 8 supplied from housing 4, and for bringing heating and/or cooling medium 8 to a temperature that is desirable in battery device 1. The more detailed embodiment is left to the respective specific embodiment and the respective application purpose. Heating and/or cooling device 15 also has an heating element 19 using which, heat energy is able to be supplied to an heating and/or cooling medium 8, supplied from housing 4, that has too low a temperature. In this connection, heating element 19 may be developed as an electrical heating element 20 or as a liquid heat exchanger 18, depending on the circumstances and the respective requirements. It is only important, in this instance, that heat energy is able to be supplied via heating element 19 to heating and/or cooling medium 8, that is to be cooled for the operation of battery device 1, in such an housing that will accommodate the battery device. Cylindrical, planar or even prismatic cells are used as the batteries, and for these cell types, the arrangement described is equally suitable.

Additional advantageous specific embodiments are established by the dependent claims and by combinations of the dependent claims.

### BRIEF DESCRIPTION OF THE SEVERAL VIEWS OF THE DRAWINGS

The present invention will be explained in greater detail below, with the aid of exemplary embodiments, the present invention not being restricted to the exemplary embodiments described. The figures show:

FIG. 1 shows a schematic representation of a battery device, having a thermostatically controlled circulatory system.

FIG. 2 shows the design of a battery device made of cylindrical individual cells packed like a tightest close packing in a front view.

### DETAILED DESCRIPTION OF THE INVENTION

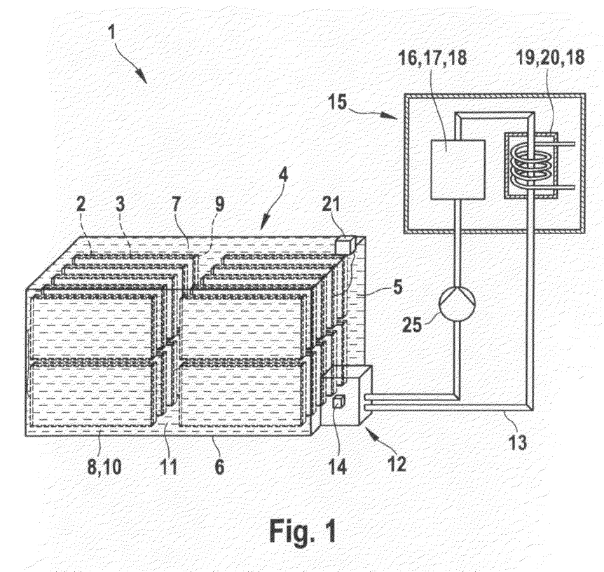

FIG. 1 shows a schematic representation of a battery device 1, made up of several batteries 2, that are developed as planar individual cells 3. These have been inserted, at a distance from one another, in a housing 4, the individual batteries 2 in each case being at a distance from sidewalls 5 and a bottom 6 and a cover 7 of housing 4. Housing 4 is filled completely with a heating and/or cooling medium 8. Batteries 2 are insulated and protected from heating and/or cooling medium 8 by an enclosure 9, that in each case individually envelops each planar individual cell 3. In this case, heating and/or cooling medium 8 is an incombustible medium 10, which contains a fireproofing agent 11 as well. Housing 4 has an interface adequate quantity that battery device 1 reaches the required temperature level. Battery device 1 also has a terminal block 21 for the electrical contacting of battery device 1 to devices lying outside of itself, especially for contacting to electrical consumers or to a vehicle electrical system. Heat exchanger 16 and heating element 19 may also be embodied as a combination element that fulfills both functions.

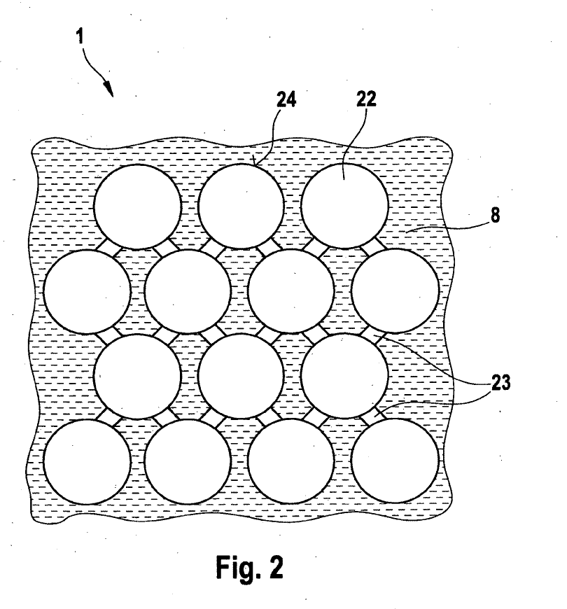

As a cutout, FIG. 2 shows the design of a battery device 1 made up of cylindrical individual cells 22 according to the principle of tightest close packing, in a frontal view. The cylindrical individual cells 22, in this case, are situated above one another by layers in such a way that, between two cylindrical individual cells, and above them, approximately centrically, an additional cylindrical individual cell is situated, so that one is able to achieve as complete and inclusive as possible a utilization of available space, according to the principle of tightest close packing. Between cylindrical individual cells 22, spacers 23 are situated in each case, in this instance, which permit a flow over the whole surface and on all sides around cylindrical individual cells 22, of heating and/or cooling medium 8. What is essential, in this instance, is that the heating and/or cooling medium act upon surfaces, or rather outer jackets 24, that are as large as possible, of cylindrical individual cells 22, so that as good and efficient as possible a heat transfer is possible between the cylindrical individual cells 22 and the heating and/or cooling medium 8.

1-10. (canceled)

11. A battery device comprising: at least one battery and at least one of a heating device and a cooling device temperature-controlling the battery, wherein the battery is submerged in a heating or cooling medium and is situated in a housing that accommodates said heating or cooling medium.

12. The battery device as recited in claim 11, wherein the heating or cooling medium is conveyed in a circulatory system, and at least one of a heating device and a cooling device for the heating or cooling medium is located in the circulatory system.

13. The battery device as recited in claim 11, wherein the battery is enveloped by a hermetically sealed enclosure on all sides.

14. The battery device as recited in claim 12, wherein the battery is enveloped by a hermetically sealed enclosure on all sides.

15. The battery device as recited in claim 13, wherein the enclosure is a foil.

16. The battery device as recited in claim 14, wherein the enclosure is a foil.

17. The battery device as recited in claim 13, wherein the inside of the enclosure is evacuated.

18. The battery device as recited in claim 14, wherein the inside of the enclosure is evacuated.

19. The battery device as recited in claim 11, wherein the battery has encapsulated or bonded contact locations or terminal locations for insulation from the heating or cooling medium.

20. The battery device as recited in claim 12, wherein the battery has encapsulated or bonded contact locations or terminal locations for insulation from the heating or cooling medium.

21. The battery device as recited in claim 13, wherein the battery has encapsulated or bonded contact locations or terminal locations for insulation from the heating or cooling medium.

22. The battery device as recited in claim 15, wherein the battery has encapsulated or bonded contact locations or terminal locations for insulation from the heating or cooling medium.

23. The battery device as recited in claim 17, wherein the battery has encapsulated or bonded contact locations or terminal locations for insulation from the heating or cooling medium.

24. The battery device as recited in claim 11, wherein the heating or cooling medium is an incombustible medium.

25. The battery device as recited in claim 12, wherein the heating or cooling medium is an incombustible medium.

26. The battery device as recited in claim 11, wherein the heating or cooling medium is an electrically nonconductive medium.

27. The battery device as recited in claim 12, wherein the heating or cooling medium is an electrically nonconductive medium.

28. The battery device as recited in claim 11, wherein the heating or cooling medium is a fireproofing agent or contains a fireproofing agent.

29. A method for temperature-controlling a battery device as recited in claim 11.
